(19) United States
(12) Patent Application Publication
(10) Pub. No.: US 2015/0012124 A1
(43) Pub. Date: Jan. 8, 2015

(54) Maintenance System, and Substrate Processing Device

(71) Applicant: TOKYO ELECTRON LIMITED, Tokyo (JP)

(72) Inventor: Tsutomu HIROKI, Nirasaki City (JP)

(21) Appl. No.: 14/495,353

(22) Filed: Sep. 24, 2014

Related U.S. Application Data
(63) Continuation of application No. PCT/JP2013/058375, filed on Mar. 22, 2013.

(30) Foreign Application Priority Data
Mar. 27, 2012 (JP) 2012-071743

(51) Int. Cl. G05B 9/02; G05B 19/418

(52) U.S. Cl. CPC G05B 9/02; G05B 19/418; G05B 2219/14007
USPC 700/121

(57) ABSTRACT

The present disclosure provides a maintenance system, installed in a substrate processing device, is comprised of an equipment control unit, a sensor acquisition unit and determination unit and control signal generation unit. The equipment control unit operates the monitored equipment within the substrate processing device. The sensor acquisition unit and determination unit can detect when a person has entered the substrate processing device. The control signal generation unit outputs a signal to stop the monitored equipment when a person is detected within the substrate processing device.

### CROSS-REFERENCE TO RELATED APPLICATIONS

This application is a Continuation Application of PCT International Application No. PCT/JP2013/058375, filed Mar. 22, 2013, which claimed the benefit of Japanese Patent Application No. 2012-071743, filed Mar. 27, 2012, the entire content of each of which is hereby incorporated by reference.

### TECHNICAL FIELD

The present disclosure relates to a maintenance system for a substrate processing device.

### BACKGROUND

In the related art, there is known a substrate processing device that allows a repairman to enter the device to perform a maintenance work. The substrate processing device includes a maintenance door through which a repairman can enter the device, a sensor which detects opening/closing of the maintenance door, and a control unit which prevents equipment within a housing of the substrate processing device from being activated if the sensor detects that the maintenance door is opened. When a repairman opens the maintenance door and enters the device, the operation of the device is prohibited. Thus, worker safety is enhanced for the repairman.

When maintaining a substrate processing device, it is sometimes necessary to accurately check the operation of equipment arranged within the housing of the device for inspecting and investigating the causes of malfunctions. Sometimes, the repairman has to activate the device to check the moving parts while the maintenance door is open. In such a substrate processing device, it is difficult to ensure the safety of the repairman when the repairman has to activate the device while performing the maintenance work. There has been an unmet demand for improved safety under such circumstances.

### SUMMARY

One aspect of the present disclosure is a maintenance system installed in a substrate processing device. The maintenance system includes an equipment control unit, a human presence detection unit, and a control signal generation unit. The equipment control unit is configured to operate the monitored equipment located within the substrate processing device. The human presence detection unit is configured to detect the entry of a human worker into the substrate processing device. The control signal generation unit is configured to output a signal to the equipment control unit that stops operation of the monitored equipment, when a human worker is detected to have entered the device.

In the maintenance system, if a human worker is detected within the device by the human presence detection unit, the control signal generation unit outputs a signal to the equipment control unit that stops the operation of the monitored equipment. Therefore, even if a repairman purposely activates the equipment with the maintenance door open while performing the maintenance work, and enters the device, it is possible to ensure the safety of the repairman. This provides a safer work environment for the repairman.

In one embodiment, the human presence detection unit may detect a human worker in the substrate processing device based upon human life signs. With this configuration, it is possible to properly detect the entry of a human worker into the substrate processing device.

In another configuration, the maintenance system includes an equipment control unit, a location unit and a control signal generation unit. The equipment control unit is configured to operate the monitored equipment located within the substrate processing device. The location unit is configured to detect the location of a human worker within the substrate processing device. The control signal generation unit is configured to calculate the distance between the monitored equipment and the human worker based on the location of the monitored equipment and the detected location of the human worker. Furthermore, the control signal generation unit outputs a signal to stop the operation of the monitored equipment if the distance is not greater than a predetermined minimum safety distance.

In the maintenance system, if the human worker inside the substrate processing device is detected to be closer to the monitored equipment than a predetermined minimum safety distance, the control signal generation unit outputs a signal for stopping the operation of the monitored equipment to the equipment control unit. Therefore, even when the repairman has to operate the equipment while inside the substrate processing device, it is possible to ensure the safety of the repairman. This provides a safer work environment for the repairman.

In one embodiment, the equipment control unit may be configured to move the monitored equipment. The control signal generation unit may be configured to acquire the path of the monitored equipment from the equipment control unit and to calculate the distance between the monitored equipment and the human worker based on the path of the equipment in motion and the location of the human worker. With this configuration, if the repairman is in the path of the monitored equipment, it is possible to stop the monitored equipment, thereby ensuring the safety of the repairman. This provides a safer work environment for the repairman.

In one embodiment, the equipment control unit may be configured to control the heat output of the monitored equipment. With this configuration, it is possible to ensure the safety of the repairman who may come in contact with hot surfaces such as, for example, a heater. This provides a safer work environment for the repairman.

The substrate processing device includes the aforementioned maintenance system. Thus, the substrate processing device provides the same safety enhancements provided by the maintenance system.

### BRIEF DESCRIPTION OF THE DRAWINGS

The accompanying drawings, which are incorporated in and constitute a part of the specification, illustrate embodiments of the present disclosure, and together with the general description given above and the detailed description of the embodiments given below, serve to explain the principles of the present disclosure.

FIG. 1 is an overall schematic diagram of a substrate processing device according to one embodiment of the present disclosure.

FIG. 2 is a schematic configuration view of a maintenance system installed in the substrate processing device shown in FIG. 1.

FIG. 3 is a schematic diagram showing the details of the substrate processing device which includes the maintenance system shown in FIG. 2.

FIG. 4 is a flowchart illustrating the operation of the maintenance system shown in FIG. 2.

FIG. 5 is a schematic diagram illustrating one example of the human presence sensor information.

FIG. 6 is a schematic diagram showing the details of the substrate processing device which includes a maintenance system according to a modified example.

### DETAILED DESCRIPTION

Embodiments of the present disclosure will now be described in detail with reference to the accompanying drawings. In the respective drawings, identical or equivalent parts will be designated by like reference symbols. In the following detailed description, numerous specific details are set forth in order to provide a thorough understanding of the present disclosure. However, it will be apparent to one of ordinary skill in the art that the present disclosure may be practiced without these specific details. In other instances, well-known methods, procedures, systems, and components have not been described in detail so as not to unnecessarily obscure aspects of the various embodiments.

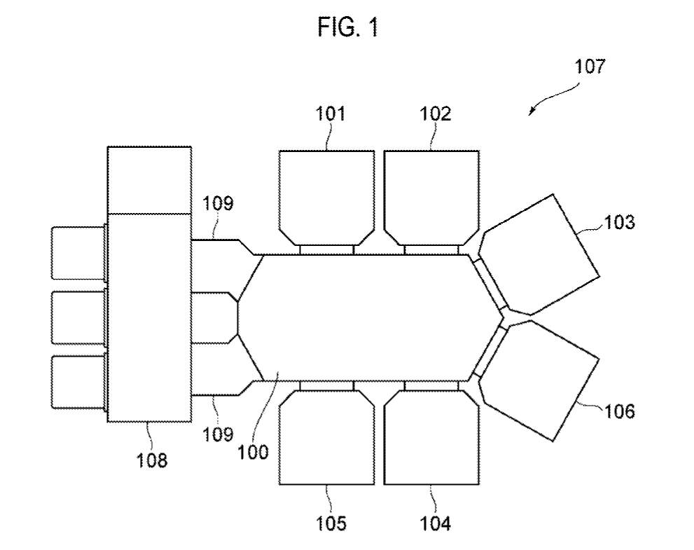

FIG. 1 is an overall schematic diagram of a substrate processing device according to one embodiment of the present disclosure. As shown in FIG. 1, the substrate processing device 107 includes a carry-in/carry-out part 108, load lock chambers 109, a transfer chamber 100 and processing modules 101 to 106. In the substrate processing device 107, a substrate is carried from the carry-in/carry-out part 108 into and out of the transfer chamber 100 through two load lock chambers 109. The substrate is carried from the transfer chamber 100 into and out of the respective processing modules 101 to 106. The present disclosure is not limited to the above, and the substrate processing devices 107 may have any suitable number and/or arrangement of installed processing modules.

The processing modules 101 to 106 may include, for example, film forming modules, doping modules, and etching modules. All the chambers of the processing modules 101 to 106 are vacuum containers connected to vacuum pumps. These chambers are configured to perform vacuum transfer and sealed from the atmosphere. Each of the chambers may have one or more of a gas supply mechanism, a pressure control mechanism, a film forming temperature control mechanism, a substrate attracting mechanism, and a plasma generating mechanism.

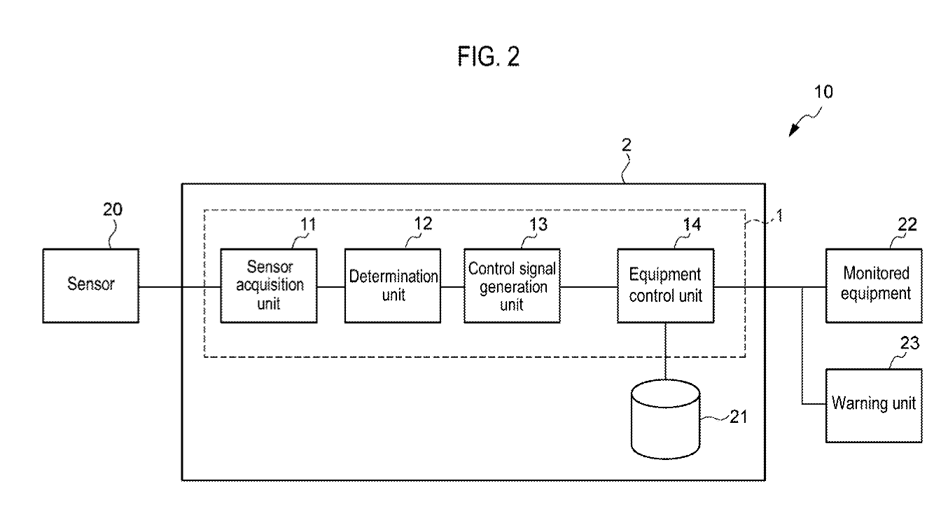

FIG. 2 is a schematic configuration view of a maintenance system installed in the substrate processing device shown in FIG. 1. As shown in FIG. 2, the maintenance system 10 includes a sensor 20, a control unit 2, a monitored equipment 22 and a warning unit 23.

The sensor 20 is installed in a housing (the monitored region) of the substrate processing device 107 where the monitored equipment 22 is located. The sensor 20 is configured to obtain signals within the housing. The monitored equipment 22 can be any predetermined equipment including a transfer robot or a heat generating device such as an electric heater. If the monitored equipment 22 is a transfer robot, the sensor 20 is installed in the carry-in/carry-out part 108 illustrated in FIG. 1. Thus, the sensor 20 may obtain signals within the carry-in/carry-out part 108.

In one embodiment, the sensor 20 may detect an entry of a human worker (e.g., a repairman) into the substrate processing device 107. That is, the sensor 20 may detect the presence of a human being. Examples of such a sensor 20 include a temperature sensor that detects the body temperature of a human being, a carbon dioxide concentration sensor that detects the breath of a human being, a sound sensor, or a vibration sensor that detects the heartbeat of a human being, an image sensor or a vibration sensor that detects a motion made by a human being, a pressure sensor arranged on the floor of the housing to detect a body weight of a human being, or a particle sensor that detects dusts generated from a human body (a material from clothes, skin particles, or hair). In one embodiment, the sensor 20 may obtain the location of the human worker (e.g., a repairman) who has entered the substrate processing device 107. Examples of such sensors include image sensors or sound sensors. The number and types of sensors can differ depending on the type, size, and environment of the device.

The control unit 2 controls the operation of the substrate processing device 107. Physically, the control unit 2 is a computer system that includes a CPU, RAM and ROM as the main storage units, a secondary storage unit such as a hard disk, and a data transmitting/receiving device such as a network card as a communication interface. The control unit 2 implements the functions described below.

Functionally, the control unit 2 includes a sensor acquisition unit 11, a determination unit 12, a control signal generation unit 13 and an equipment control unit 14. The sensor acquisition unit 11 receives a detection value from the sensor 20 and outputs the detection value to the determination unit 12. The determination unit 12 determines the internal condition of the monitoring region based on the detection value of the sensor 20. In one embodiment, the determination unit 12 may determine that a human being has entered the substrate processing device 107 based on the value from the sensor 20. For example, in case where a temperature sensor (a thermograph) is used as the sensor 20, the determination unit 12 determines whether there is an object with a temperature within in the range of human body temperature (e.g., 36 degrees C. to 40 degrees C.) within the monitored region. If such an object exists, the determination unit 12 determines that a human being has entered the device. Similarly, when sensor 20 is a carbon dioxide concentration sensor, the determination unit 12 determines whether there is a carbon dioxide concentration equal to or larger than a predetermined value. If the carbon dioxide concentration reading exceeds predetermined value, the determination unit 12 determines that a human being has entered the device. Similarly, when sensor 20 includes sound sensors, or vibration sensors, the determination unit 12 determines whether the readings match the heart rate profile of a human being. If the readings match the human heart rate profile, the determination unit 12 determines that a human being has entered the device. Similarly, when sensor 20 includes an image or a vibration sensor, the determination unit 12 determines whether the motion of an object detected by the sensor is equal to or larger than a predetermined value. If the sensor detection value is equal to or larger than the predetermined value, the determination unit 12 determines that a human being has entered the device. Similarly, when sensor 20 is a pressure sensor, the determination unit 12 determines whether the there is an object within the average body weight range a repairman (e.g., 40 to 100 kg). If the there is such an object within the monitored region, the determination unit 12 determines that a human being has entered the device. Similarly, when sensor 20 is a particle sensor, the determination unit 12 determines whether the sensor reading is equal to or larger than a predetermined value. If the sensor reading is equal or larger than the predetermined value, determination unit 12 determines that a human being has entered the device. The determination unit 12 outputs a determination result to the control signal generation unit 13.

In one embodiment, the determination unit 12 may obtain the location of the human being who has entered the substrate processing device 107 and may output the location of the human being to the control signal generation unit 13.

Based on the output signal from the determination unit 12, the control signal generation unit 13 determines whether to stop the monitored equipment 22 and generates a control signal based on the determination result. For example, if the determination result indicates that a human being is inside the device, the control signal generation unit 13 outputs a control signal for stopping the monitored equipment 22 to the equipment control unit 14. This control signal will stop the monitored equipment 22 upon detecting that a human being has entered the monitored region.

In one embodiment, the control signal generation unit 13 may calculate the distance between the monitored equipment and the human based on the locations of both the human being, who is inside the substrate processing device 107, and the monitored equipment 22. If the distance is not greater than a predetermined minimum safety distance, the control signal generation unit 13 may output a signal to the equipment control unit 14 for stopping the operation of the monitored equipment 22. This makes it possible to determine whether the human inside the monitored region of the device is safe. If there is any possibility of danger, the monitored equipment 22 can be stopped.

The equipment control unit 14 controls the operation of the monitored equipment 22, for example, by referring to an equipment control information database 21. When the monitored equipment 22 has moving parts, such as a transfer robot, the equipment control information database 21 stores the movement velocity, movement acceleration, path information, timing information or the combination thereof. For example, if the monitored equipment 22 is a heater, which generates heat, the heat output (temperature and time), timing information or the combination thereof is stored in the equipment control information database 21.

Upon receiving a signal for stopping the operation of the monitored equipment 22 from the control signal generation unit 13, the equipment control unit 14 stops the operation of the monitored equipment 22. If the monitored equipment 22 has moving parts, such as a transfer robot, the equipment control unit 14 stops the movement of the moving parts. For example, if the monitored equipment 22 is a heater, which generates heat, the equipment control unit 14 will turn the heat off Prior to stopping the operation of the monitored equipment 22, the equipment control unit 14 may activate a warning unit 23 to notify the human being who has entered the device of danger. In this case, the equipment control unit 14 may stop the operation of the monitored equipment 22 after outputting the warning signal.

When the monitored equipment 22 has moving parts, such as a transfer robot, the control signal generation unit 13 may obtain the path of the moving parts from the equipment control unit 14 and calculate the distance between the monitored equipment 22 and the human being inside the device based on the path information and the location of the human being. If the distance is not greater than a predetermined minimum safety distance, the control signal generation unit 13 may output a signal to the equipment control unit 14 for stopping the operation of the monitored equipment 22. This makes it possible to properly determine whether the human being inside of the device is safe. If there is any possibility of danger, the monitored equipment 22 can be stopped.

In the maintenance system 10 described above, the sensor acquisition unit 11 and the determination unit 12 serve as a human presence detection unit or a location detecting unit. Thus, the maintenance system 10 includes, as its minimum configuration, a maintenance control part 1 which includes the sensor acquisition unit 11, the determination unit 12, the control signal generation unit 13 and the equipment control unit 14. In some embodiments, the maintenance system 10 may not include the sensor 20, the equipment control information database 21, the monitored equipment 22, or the warning unit 23, if such components are not needed.

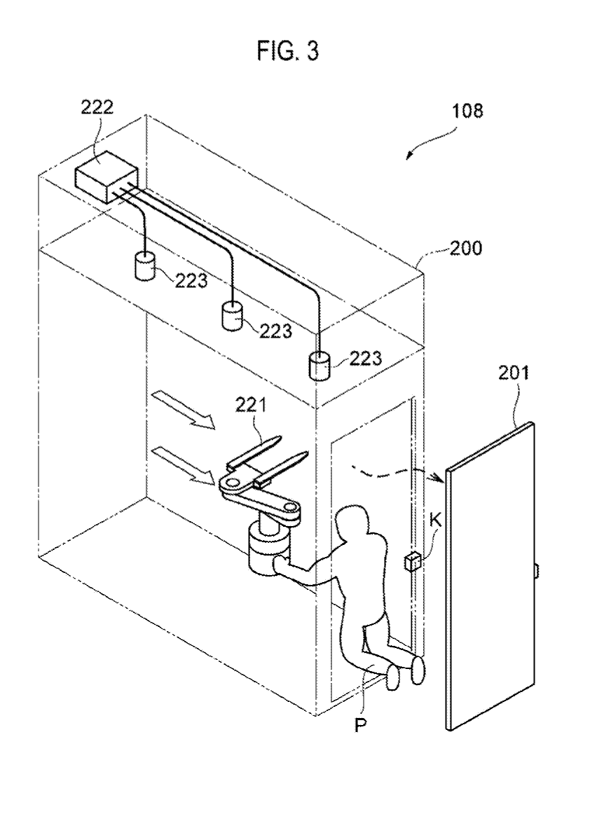

Next, the operation of the maintenance system 10 will be described according to one embodiment of the present disclosure. For the purpose of this description, a specific installation instance of the maintenance system 10 in FIG. 3 will be used. FIG. 3 shows a schematic diagram of the substrate processing device 107 which includes the maintenance system 10 shown in FIG. 2. The monitored region is the carry-in/carry-out part 108, the monitored equipment 22 is a transfer robot, and the sensor 20 is a temperature sensor. The carry-in/carry-out part 108 includes a housing 200 and a transfer robot 221 arranged within the housing 200. The transfer robot 221 is a robot for transferring a wafer and can move upward, downward, leftward and rightward within the housing 200. Temperature sensors 223 for measuring an internal temperature of the carry-in/carry-out part 108 are placed in the upper portion of the housing 200. The temperature sensors 223 are connected to a controller 222.

A safety cover 201 is attached to the housing 200. A repairman can enter the housing 200 by opening the safety cover 201. A cover sensor K that can detect the opening/closing of the safety cover 201 is installed in the housing 200. The cover sensor K is configured such that, using an ON/OFF switch, a repairman P can select whether to detect the opening/closing of the safety cover 201. The opening/closing detecting sensor K is connected to the controller 222.

If the opening of the safety cover 201 is detected by the cover sensor K, the controller 222 stops the transfer robot 221. The repairman P can deactivate the cover sensor K using the ON/OFF switch, and then enter inside the carry-in/carry-out part 108 and operate the transfer robot 221 even with the safety cover 201 open.

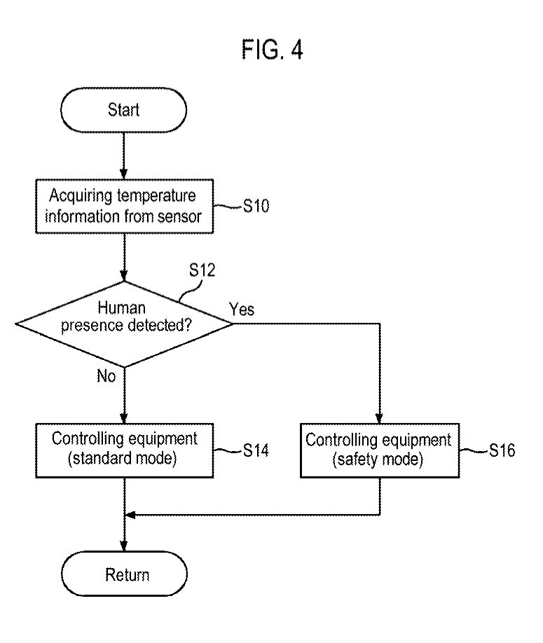

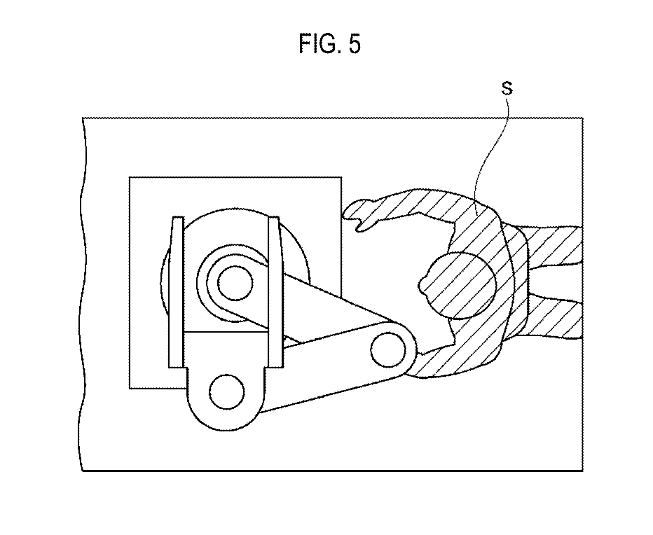

In the configuration described above, the maintenance system 10 performs the operation shown in FIG. 4. The operation shown in FIG. 4 is repeatedly performed at specified intervals while the power of the substrate processing device 107 is on. As shown in FIG. 4, the sensor acquisition unit 11 of the controller 222 initially acquires temperature information from the temperature sensors 223 (S10). For example, the temperature information shown in FIG. 5 is acquired. Next, based on the temperature information acquired in the process of S10, the determination unit 12 determines whether a human being is present (S12). For example, based on the temperature distribution of the thermography shown in FIG. 5, the determination unit 12 determines that a human being is present within the housing if there is a continuous region having a temperature between 35 degrees C. to 40 degrees C. In the current example, if the temperature of region S shown in FIG. 5 is approximately 36 degrees C., the determination unit 12 determines that a human being is present. If it is determined in process S12 that a human being is not detected, an ordinary equipment control is implemented by the equipment control unit 14 (S14), and the control sequence shown in FIG. 4 will end. On the other hand, if process S12 detects a human being, a signal to stop the transfer robot 221 is outputted by the control signal generation unit 13. The operation of the transfer robot 221 is stopped by the equipment control unit 14. Then, the control sequence shown in FIG. 4 is ended.

As described above, the maintenance system 10 detects the repairman P who has entered the carry-in/carry-out part 108. If the repairman P is detected, the control signal generation unit 13 outputs a signal to stop the operation of the transfer robot 221 to the equipment control unit 14. Even if the repairman P enters the device by opening the safety cover 201 and performs the maintenance work that involves purposely activating the equipment, it is possible to ensure the safety of the repairman P. This provides a safer work environment for the repairman.

For some kinds of maintenance work, such as when the repairman is trying to find an abnormal noise, the repairman may need to activate the transfer robot 221 while he is inside the device with the safety cover 201 off. In this case, processes S10 and S12 shown in FIG. 4 can be modified in the following manner, so that it becomes possible to perform the maintenance work while ensuring the safety of the repairman P. For example, in process S10, the sensor 20 acquires the location of the repairman P. The control signal generation unit 13 acquires the path (the changing location depending on time) of the transfer robot 221. In process S12, the control signal generation unit 13 calculates the distance between the transfer robot 221 and the repairman P. If the distance is greater than a predetermined minimum safety distance, the flow proceeds to process S14 where the transfer robot 221 is controlled in a standard mode and then the control sequence is ended. On the other hand, if the distance is not greater than the predetermined minimum safety distance, the flow proceeds to the process of S16 where the transfer robot 221 is controlled in a safety mode (i.e., the operation of the transfer robot 221 is stopped) and then the control sequence is ended. By operating the transfer robot 221 in this manner, it is possible to ensure the safety of the repairman P even when it is necessary for the repairman to enter the device by opening the safety cover 201, and to then activate the equipment. This provides a safer work environment for the repairman.

The aforementioned control using distance is not limited to cases where the monitored equipment 22 is a transfer robot 221, but may also be applied to, for example, when the monitored equipment 22 generates heat, such as an electric heater.

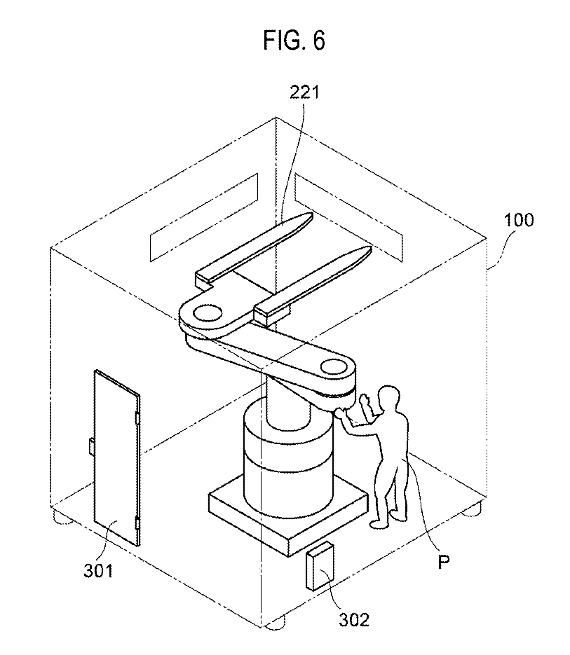

The maintenance system 10 described above can be used to monitor different locations of the substrate processing device 107 and is not limited to the carry-in/carry-out part 108. For example, as shown in FIG. 6, the maintenance system 10 may be applied to a transfer chamber 100 with a maintenance door 301. In FIG. 6, a carbon dioxide concentration sensor 302 located in the lower portion of the transfer chamber 100 functions as the sensor 20. The carbon dioxide concentration sensor 302 is connected to a control unit 2 (not shown). Thus, even if the maintenance door 301 is inadvertently closed while the repairman P is working within the transfer chamber 100, the operation of the transfer robot 221 is stopped. This makes it possible to ensure the safety of the repairman P.

As mentioned above, according to different aspects and embodiments of the present disclosure, it is possible to enhance the safety of the maintenance work.

While one embodiment has been described above, the present disclosure is not limited to this embodiment but may be configured in many different modified forms. For example, the operation of the monitored equipment 22 may be slowed down or the heat output may be reduced depending on the distance between the repairman P and the monitored equipment 22.

What is claimed is:

1. A maintenance system installed in a substrate processing device, comprising:
an equipment control unit configured to operate monitored equipment located within the substrate processing device;
a human presence detection unit configured to detect an entry of a person into the substrate processing device; and
a control signal generation unit configured to output a signal to the equipment control unit for stopping the operation of the monitored equipment if the entry of the person into the substrate processing device is detected by the human presence detection unit.

2. The maintenance system of claim 1, wherein the human presence detection unit is configured to detect the entry of the person into the substrate processing device based on human presence signs.

3. A substrate processing device comprising the maintenance system of claim 1.

4. A maintenance system installed in a substrate processing device, comprising:
an equipment control unit configured to operate a monitored equipment disposed within the substrate processing device;
a location unit configured to detect a location of a person within the substrate processing device; and
a control signal generation unit configured to calculate a distance between the monitored equipment and the person based on a location information of the monitored equipment and a location information of the person, and output a signal for stopping an operation of the monitored equipment to the equipment control unit if the distance is not greater than a predetermined minimum safety distance.

5. The maintenance system of claim 4, wherein the equipment control unit is configured to move the monitored equipment, and
the control signal generation unit is configured to acquire a path of the monitored equipment from the equipment control unit and to calculate the distance between the monitored equipment and the person based on the path of the monitored equipment and the location of the person.

6. The maintenance system of claim 4, wherein the equipment control unit is configured to control a heat output of the monitored equipment by operating the monitored equipment.

7. A substrate processing device comprising the maintenance system of claim 4.
